(19) United States
(12) Patent Application Publication
(10) Pub. No.: US 2022/0010612 A1
(43) Pub. Date: Jan. 13, 2022

(54) Fire Resistant Door Panel, Method of Manufacture and Installation Thereof

(71) Applicant: Fire Door Core Pty Ltd, Revesby (AU)

(72) Inventor: Damian Scamarcia, Sydney (AU)

(73) Assignee: Fire Door Core Pty Ltd, Revesby (AU)

(21) Appl. No.: 17/373,974

(22) Filed: Jul. 13, 2021

(30) Foreign Application Priority Data
Jul. 13, 2020 (AU) 2020902413

(51) Int. Cl. E06B 5/16; E06B 3/70; E06B 3/82

(52) U.S. Cl. CPC E06B 5/164; E06B 2003/704; E06B 3/822; E06B 3/7015

(57) ABSTRACT

A fire resistant panel for a fire door, the panel including a frame providing a rigid bordering structure for the panel and having an inner face, an outer face, an inner side and an outer side, the frame surrounding an inner space; and a core disposed within the inner space, the core having a peripheral edge adjacent the inner side of the frame.

### TECHNICAL FIELD

This disclosure relates generally to fire doors and components therefor, and methods for the manufacture of same. The disclosure is also concerned with a method of installation of a fire door.

### BACKGROUND ART

Fire doors are fire resistant closures which are installed in buildings and other structures to reduce the spread of fire and smoke from one zone to another. Fire doors are generally subject to strict building codes which are governed by authorities in a jurisdiction. Fire doors are generally given a rating which needs to be complied with. Fire ratings are a numerical rating quantified in minutes of resistance to a fire.

There are many types of fire doors currently in use. One example of a conventional/prior art fire door panel 100 is shown in FIG. 3. As shown, the panel includes a fire resistant core 101 with timber edging 102 around the core periphery. Steel reinforcement plates 103 are included to reinforce certain edge regions of the core. The plates 103 are required as the core material does not have any screw fixing capability (i.e., the plates allow for screw fixing of hinges, latches and other components to the core). The core is also sandwiched between two plywood faces/sheets 104. One issue with these prior art panels/doors is that the reinforcement plates limit the possibility for trimming of the panel beyond the timber edging. Trimming is often necessary, for example, to fit a fire door/panel to a particular door cavity, or to customize/resize standard fire door blanks.

There is a need for a fire door which is of relatively uncomplicated construction/manufacture, has improved fire resistant properties, can be easily trimmed, and can be installed in an efficient manner.

### SUMMARY OF DISCLOSURE

In a first aspect, embodiments are disclosed of a fire resistant panel for a fire door, the panel comprising: a frame providing a rigid bordering structure for the panel and having an inner face, an outer face, an inner side and an outer side, the frame surrounding an inner space; and a core disposed within the inner space, the core having a peripheral edge adjacent to the inner side of the frame.

In certain embodiments, the frame comprises two stiles and two rails fitted together to form a generally rectangular frame structure, the inner space being surrounded by the rectangular frame structure, the core being sized so as to fit within the space, the peripheral edge of the core being secured to the inner side of the frame.

In certain embodiments, an intumescent strip is secured to and extends at least partially around the outer side of the frame.

In certain embodiments, the intumescent strip is fitted within a groove in the outer side of the stiles and one of the rails, the strip having an exposed face when fitted, the grooves and associated intumescent strip extending substantially the entire length of the stiles and rail to which it is fitted.

In certain embodiments, the stiles and rails are secured together with an adhesive such as, for example, a ceramic adhesive.

In certain embodiments, the core may be formed from vermiculite, the frame may be formed from a refractory material such as magnesium sulphate or calcium silicate, and the intumescent strip may be formed from a combination of graphite and sodium palusol.

In certain embodiments, the panel further includes at least one door skin or sheet secured to one of either the inner face or outer face of the frame and the core.

In certain embodiments, the panel includes a further door skin or sheet secured to the other of the inner face or outer face of the frame and the core.

In certain embodiments, the frame and the core are secured to the or each door skin or sheet with an adhesive.

In a further aspect, embodiments are disclosed of a method of installing a fire door in a door opening at an installation site, the fire door including a fire resistant panel as described above, the method comprising the steps of manufacturing the panel to a standardized size and, at the installation site, subsequently trimming the standardized panel so as to properly fit the door opening in which it is to be installed.

In a further aspect, embodiments are disclosed of a method of manufacturing a panel for a fire resistant door, the panel including a frame which has an inner face, an outer face, an inner side, and an outer side, the frame at least partially surrounding an inner space, the panel further including a core and at least one door skin or sheet, the method including the steps of: securing one of the faces of the frame to the door skin or sheet, positioning the core within the inner space and securing the core to the door skin or sheet.

In certain embodiments, the method includes the step of securing a further door skin or sheet to the other of the faces of the frame and to the core.

In certain embodiments, the frame and core are secured to one or both of the door skins by an adhesive.

In certain embodiments, the method includes the further step of fitting an intumescent strip to at least part of the outer side of the frame.

### BRIEF DESCRIPTION OF THE DRAWINGS

Notwithstanding any other forms which may fall within the scope of the method and apparatus set forth in the summary, specific embodiments of the method and apparatus will now be described by way of example and with reference to the accompanying drawings in which:

FIG. 1 is a schematic illustration of a door panel according to one embodiment;

FIG. 2 is a schematic illustration of part of a door panel according to a further embodiment; and

FIG. 3 is a schematic illustration of a conventional/prior art fire door panel.

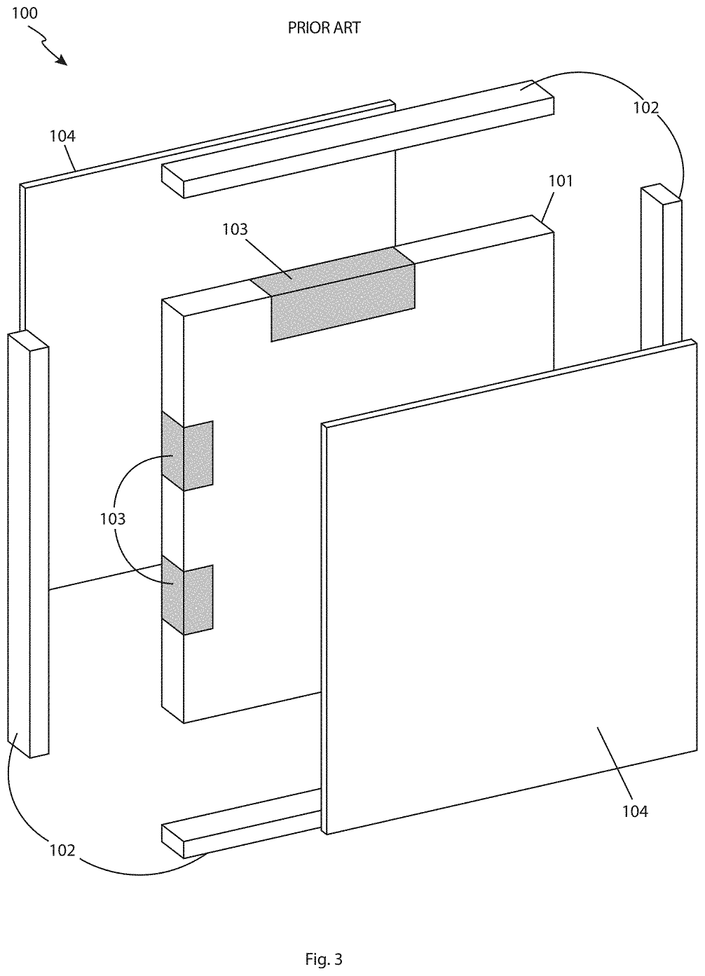

### DETAILED DESCRIPTION

Referring to the drawings, there is illustrated a panel generally indicated at 10 which in one particular application forms part of a fire door. The panel 10 includes a frame 15 which, in the form shown, comprises elongated side members or stiles 40 and 50 and top and bottom cross members or rails 20 and 30 which are secured or fitted together to form a rigid structure. In the embodiment illustrated, the frame 15 is generally rectangular in shape although it could be of other shapes having regard to its application. The frame 15 has opposed or oppositely facing inner and outer faces 13 and 14, an inner side 16 and an outer side 17, and forms a peripheral section of the panel 10, with an interior space 18 which is bounded by the frame 15. The panel 10 further includes a core 60 which is disposed within the space 18.

The top and bottom cross members or rails 20 and 30 are generally square or rectangular when viewed in cross-section, each including an inner side 21 and 31, and outer side 22 and 32, a front face 23 and 33, a rear face 24 and 34, and ends 25/26 and 35/36. The side members or stiles 40 and 50 are also generally square or rectangular when viewed in cross-section, each including an inner side 41 and 51, an outer side 42 and 52, a front face 43 and 53, a rear face 44 and 54, and ends 45/46 and 55/56. The front and rear faces of the stiles, 40 and 50, and rails, 20 and 30, provide for the inner and outer faces, 13 and 14, of the frame 15.

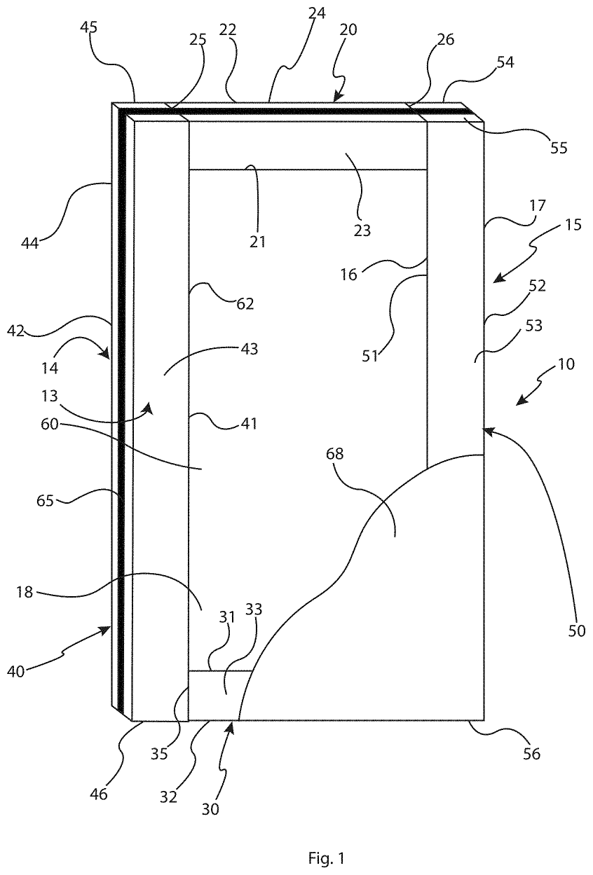

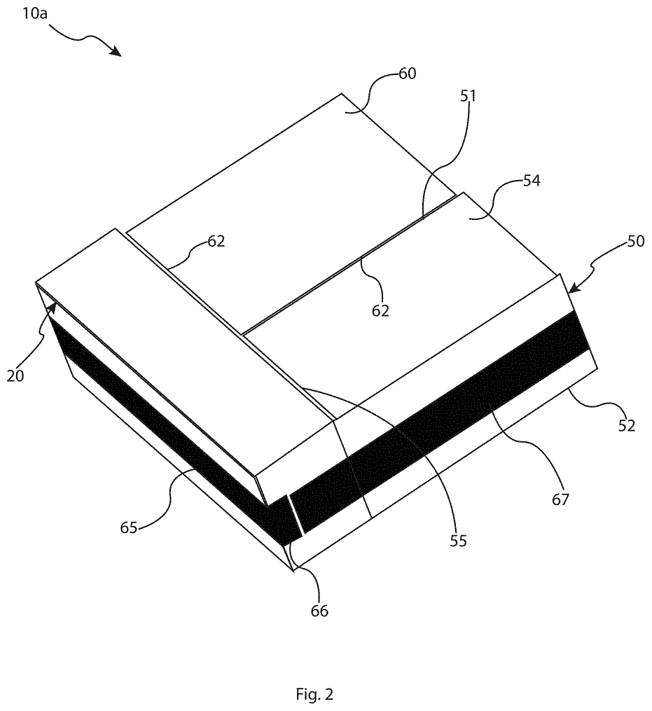

As shown in FIG. 1, the ends 25/26 and 35/36 of the top and bottom cross members or rails 20 and 30 are joined to the insides 41 and 51 of the side members or stiles 40 and 50 adjacent to the ends 25/26 and 35/36 thereof. It will be appreciated that in other embodiments, like that of FIG. 2 (with panel 10A), the side members or stiles 40 and 50 may be joined to the insides 21 and 31 of the top and bottom members or rails 20 and 30 adjacent the ends 45/46 and 55/56 thereof.

The members 20, 30, 40 and 50 may be secured together by a suitable adhesive. Examples of suitable adhesives include ceramic adhesives. The frame 15 provides for a rigid structure to which door components such as hinges, door closes and door locks can be secured. The stiles and rails 20, 30, 40 and 50 may be formed from refractory materials such as magnesium sulphate or calcium silicate.

The panel 10 further includes a core 60 which is arranged within the space 18. The core 60 is complementary in shape to that of the space 18 and has a peripheral edge 62. The core 60 is sized so that the peripheral edge 62 is adjacent to the inner sides 21 and 31 of the top and bottom cross members 20 and 30, and the inner sides 41 and 51 of the side members 40 and 50. The core 60 can be formed from any suitable refractory material. In one advantageous form, the core 60 is formed from vermiculite. Desirably, the vermiculite core is of a relatively low density, typically in the range of about 350 kg/m³ to 400 kg/m³ and in one particular form, about 375 kg/m³.

The panel 10 further includes an intumescent strip 65 which is secured to the outer side 17 of the frame structure 15. In the embodiment shown, the strip 65 is secured to the outer sides 42 and 52 of the side members 40 and 50 as well as the outer side 22 of the top rail 20. To this end, the strip 65 is fitted within grooves 66 in the outer sides 42, 52 and 22 of the members 40, 50 and 20, and has an exposed face 67. It will be appreciated that the intumescent swells in instances of fire to aid in sealing the door opening in which the panel is located.

The inner 13 and outer faces 14 of the panel 10 have door skins or sheets 68 secured thereto. The door skins 68 are formed from non-combustible materials such as refractory materials, such as, for example, magnesium sulphate or calcium silicate and secured in place by an appropriate adhesive (typically ceramic adhesive).

One example of a method of assembly and manufacture of a panel 10 as described above will hereinafter be described. The components of the frame 15, core 60 and door skins 68 are cut or otherwise formed to a selected size. The stiles, 40 and 50, and rails, 20 and 30, are then assembled together using a suitable adhesive to form the frame 15. An adhesive is applied to one of the door skins 68 and/or the assembled frame 15, and the frame placed on top of the door skin 68 so that it can be adhered thereto. The core 60 is then positioned within the inner space 18 bounded by the frame 15 and also adhered to the door skin 68 using adhesive. The other door skin 68 is then placed on top of the frame 15 and core 60 and adhered thereto using an adhesive. Pressure may be applied to the assembly to ensure that the door skins 68, frame 15 and core 60 are properly secured together. The adhesive used is typically a ceramic adhesive.

The panel 10 and its method of manufacture has many advantages over currently known panels and their manufacturing techniques. As previously described, conventional panels include a timber edging and steel reinforcement plates. This prior art arrangement limits the amount of trimming which can be done to the panels, as the steel reinforcement plates limit trimming beyond the timber edging. In the present invention, the rails/stiles are formed of a material that allows screw fixing thereto (i.e., for components, hinges etc.). Also, as the rails/stiles are formed a refractory material, they can be wider (i.e. can have greater distance between their inner sides (e.g. 21, 41) and outer sides (e.g. 22, 42)) than any timber edging previously used. The advantages of the present construction are thus two fold, in the first instance the nature of the rail/stile material removes the need for steel reinforcement plates as componentry can be screw fixed directly to the rails/stiles. This in turn leads to a simplified construction/manufacturing process. In the second instance, as the rails/stiles are generally wider (i.e., when compared to previous timber edging) substantially more trimming is possible.

For example, a standard door size in some applications is approximately 2045 mm high, 820 or 920 mm wide and 35 or 45 mm thick. The width of the rail/stiles and absence of metal reinforcement typically allows trimming up to 50 mm per side and up to about 100 mm from the height. In some instances, where substantial trimming is required, it may be necessary to at least partially reform the grooves within which the intumescent strip is located. This can be effected using a router or other tool at the installation site.

A further advantage of the panel 10, which is the subject of the present disclosure, is that a door blank can be produced and can be trimmed to the required dimensions at the installation site rather than requiring complete preparation of the blank in a factory off site. Trimming on site can be effected using appropriate tools, including hand tools.

Yet another advantage of the panels according to the invention is that a door blank can be produced which can be trimmed to the required dimensions in the factory in complete preparation for installation. This allows for asymmetrical door sizing without the limitations of timber edging and steel reinforcement plates.

It will be appreciated that the presently described panel constructions are further advantageous/simpler when compared to prior art panel constructions as the skins aid with securement of the core within the frame.

In the forgoing description of preferred embodiments, specific terminology has been resorted to for the sake of clarity. However, the invention is not intended to be limited to specific terms so selected, and it is to be understood that each specific term includes all technical equivalents which operate in a similar manner to accomplish a similar technical purpose. Terms such as “front” and “rear”, “inner” and “outer”, “above”, “below”, “upper” and lower” and the like are used as words of convenience to provide reference points and are not to be construed as limiting terms.

The reference in this specification to any prior publication (or information derived from it), or to any matter which is known, is not, and should not be taken as, an acknowledgement or admission or any form of suggestions that prior publication (or information derived from it) or known matter forms part of the common general knowledge in the field of endeavour to which this specification relates.

In this specification the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

In addition, the foregoing describes only some embodiments of the invention(s), and alterations, modifications, addition and/or changes can be made thereto without departing from the scope and spirit of the disclosed embodiments, the embodiments being illustrative and not restrictive.

Furthermore, invention(s) have been described in connection with what are presently considered to be the most practical and preferred embodiments, it is to be understood that the invention is not limited to the disclosed embodiments, but on the contrary, is intended to cover various modifications and equivalent arrangements included within the spirit and scope of the invention(s). Also, the various embodiments described above may be implemented in conjunction with other embodiments, e.g. aspects of one embodiment may be combined with aspects of another embodiment to realize yet other embodiments. Further, each independent feature or component of any given assembly may contribute an additional embodiment.

### TABLE OF PARTS

Panel 10
Inner face 13
Outer face 14
Frame structure 15
Inner side 16
Outer side 17
Interior space 18
Top rail 20
Inner side 21
Outer side 22
Front face 23
Rear face 24
Ends 25/26
Bottom rail 30
Inner side 31
Outer side 32
Front face 33
Rear face 34
Ends 35/36
Stile 40
Inner side 41
Outer side 42
Front face 43
Rear face 44
Ends 45/46
Stile 50
Inner side 51
Outer side 52
Front face 53
Rear face 54
Ends 55/56
Core 60
Peripheral edge 62
Intumescent strip 65
Grooves 66
Exposed face 67
Skins 68

1. A fire resistant panel for a fire door, the panel comprising:
a frame providing a rigid bordering structure for the panel and having an inner face, an outer face, an inner side and an outer side, the frame surrounding an inner space; and
a core disposed within the inner space, the core having a peripheral edge adjacent the inner side of the frame.

2. The fire resistant panel according to claim 1, wherein the frame comprises two stiles and two rails fitted together to form a generally rectangular frame structure, the inner space being surrounded by the rectangular frame structure, the core being sized so as to fit within the space, the peripheral edge of the core being secured to the inner side of the frame.

3. The fire resistant panel according to claim 2, wherein an intumescent strip is secured to and extends at least partially around the outer side of the frame.

4. The fire resistant panel according to claim 3, wherein the intumescent strip is fitted within a groove in the outer side of the stiles and one of the rails, the strip having an exposed face when fitted, the grooves and associated intumescent strip extending substantially the entire length of the stiles and the rail to which it is fitted.

5. The fire resistant panel according to claim 2, wherein the stiles and the rails are secured together with an adhesive.

6. The fire resistant panel according to claim 1, wherein the core is formed from the vermiculite.

7. The fire resistant panel according to claim 1, wherein the frame is formed from a refractory material.

8. The fire resistant panel according to claim 3, wherein the intumescent strip is formed from a combination of graphite and sodium palusol.

9. The fire resistant panel according to claim 1, further including at least one door skin or sheet secured to one of either the inner face or outer face of the frame and the core.

10. The fire resistant panel according to claim 9, including a further door skin or sheet secured to the other of the inner face or outer face of the frame and the core.

11. The fire resistant panel according to claim 9, wherein the frame and the core are secured to the door skin or sheet with an adhesive.

12. A method of installing a fire door in a door opening at an installation site, the fire door including the fire resistant panel according to claim 1, the method comprising manufacturing the panel to a standardized size and, at the installation site, subsequently trimming the standardized panel so as to properly fit the door opening in which it is to be installed.

13. A method of manufacturing a panel for a fire resistant door, the panel including a frame which has an inner face, an outer face, an inner side and an outer side, the frame at least partially surrounding an inner space, the panel further including a core and at least one door skin or sheet, the method including:
securing one of the faces of the frame to the door skin or sheet,
positioning the core within the inner space, and
securing the core to the door skin or sheet.

14. The method according to claim 13, further including securing a further door skin or sheet to the other of the faces of the frame and to the core.

15. The method according to claim 14, wherein the frame and core are secured to one or both of the door skins by an adhesive.

16. The method according to claim 13, further including fitting an intumescent strip to at least part of the outer side of the frame.
